(19) United States
(12) Patent Application Publication
(10) Pub. No.: US 2025/0007132 A1
(43) Pub. Date: Jan. 2, 2025

(54) DEVICE FOR ELECTRICALLY CONTACTING A TERMINAL

(71) Applicant: John Deere Electric Powertrain LLC, Moline, IL (US)

(72) Inventors: Helmut Kastler, Freistadt (AT); Manuel Riegler, Freistadt (AT); Georg Friesenecker, Grünbach (AT); Philipp Kregl, Kefermarkt (AT); Matthias Palmetshofer, Freistadt (AT); Philipp Kreisel, Freistadt (AT)

(21) Appl. No.: 18/708,888

(22) PCT Filed: Sep. 30, 2022
(86) PCT No.: PCT/AT2022/060344

§ 371 Date: May 9, 2024

(30) Foreign Application Priority Data
Nov. 11, 2021 (AT) A50902/2021

(51) Int. Cl. H01M 50/583; H01H 85/20; H01M 50/213; H01M 50/548

(52) U.S. Cl. CPC H01M 50/583; H01M 50/213; H01M 50/548; H01H 85/2045; H01M 2200/103

(57) ABSTRACT

A device for electrically contacting a terminal pole (2) of a battery cell (3) comprises a fuse (1) that is electrically connected to the terminal pole (2) and to a contact point (4) spaced from the terminal pole (2) in a main direction (5). The electrical connection to the terminal pole is reliably disconnected at a predetermined overcurrent, regardless of any operating conditions or faults. The fuse (1), which is connected to the terminal pole (2) via a connecting conductor (6) and is spaced from the terminal pole (2) in the main direction (5) via a spacer, runs in an insulation area (7) which is separated in the main direction (5) by an insulating element (8) from a hazard area (9) that adjoins the connecting pole (2) and through which the connecting conductor (6) passes at least in sections.

### TECHNICAL AREA

The invention relates to a device for electrically contacting a terminal pole of a battery cell, comprising a fuse which is electrically connected to the terminal pole and to a contact point spaced from the terminal pole in a main direction.

### STATE OF THE ART

Devices are known from the prior art (AT522256A1) in which the terminal pole of a battery cell is electrically contacted via a contact spring as an electrical connection. The contact spring forming a fuse comprises a contact point for an adjacent battery cell so that the two battery cells, which are spaced apart in one main direction, are electrically connected to each other. If there is an increased current flow in the event of a fault, the contact spring melts in the area of the fuse and the connection to the neighboring battery cell is disconnected.

EP3660952A1 shows a battery module with several battery cells for which two conductor plates and one insulation plate are provided on the pole side. The battery cells are electrically contacted via openings in the conductor plate using fuses.

EP3890102A1 also shows a battery module with several battery cells, which are covered on the pole side by a contact plate and a protective element with a spacer.

The battery cells are electrically contacted via fuses that are guided through openings in the contact plates.

US20170012331A1 shows a battery module with several battery cells arranged between two conductor plates. The conductor plates each have two conductor contacts per battery cell, which break, melt or burn in the event of a fault. An elastomer cushion is provided between the conductor contacts and the conductor plate, which presses the conductor contacts out of the conductor plate plane and forms an insulating layer.

However, a disadvantage of the prior art is that the electrical connection can be maintained in the event of a thermal runaway and associated outgassing of the battery cell if the terminal pole and thus the separated contact spring part are displaced. In addition, the time of melting and the current required for this can be affected by electrically conductive particles accumulating on the fuse. Finally, active cooling of the battery cells also leads to indirect cooling of the fuse, making it even more difficult to specify the actual time of melting.

### Representation of the Invention

The invention is therefore based on the problem of ensuring that the electrical connection to the terminal pole is reliably disconnected at a predetermined overcurrent, regardless of any operating conditions or fault.

The invention solves the problem set by the fact that the fuse, which is connected to the terminal pole via a connecting conductor and is spaced from the terminal pole in the main direction by a spacer, runs in an insulation area which is separated in the main direction by an insulating element from a hazard area adjacent to the terminal pole and passed through by the connecting conductor at least in sections. As a result of these measures, defined ambient conditions are created for the fuse in the insulation area on the one hand and, on the other hand, bridging of the fuse by electrically conductive particles escaping from the battery cell is prevented by the distance to the terminal pole specified by the spacer. If hot gases escape from the battery cell in the event of a fault, the preferably thermal insulating element thermally shields the insulation area from the hazard area so that components located between the insulating element and the contact point are not heated and thus damaged by any escaping hot gases on the one hand and soot formation, which further increases the undesirable electrical conductivity, is reduced in the other hand. If, in the event of a fault, electrically conductive components are unintentionally displaced into the hazard area and/or electrically conductive particles escape from the battery cell, the insulating element, which forms a physical barrier between the hazard area and the insulation area and is preferably also electrically insulating, prevents unintentional electrical contact being made between the now defective battery cell and the contact point. The spacer between the fuse and the terminal pole also prevents the battery cell's end face facing the hazard area from deforming in the event of a fault, for example due to the high pressure of the hot gas, and from protruding into the hazard area and making unwanted electrical contact itself. As a result, the distance between the terminal pole, and thus the battery cell, and the contact point can be kept essentially constant and preferably as small as possible both during normal operation and in the event of a fault. A small distance enables a more spatially efficient arrangement of the battery cell to the contact point and thus increases the energy density per volume. Accordingly, a spacer is understood to be a component that maintains the distance between the terminal pole and the fuse in all operating and fault conditions. In particular, the spacer can be dimensionally stable in all operating and fault conditions. In a preferred embodiment, the spacer has a cylindrical, in particular a circular-cylindrical basic shape and is preferably arranged centrally on the terminal pole so that the terminal pole and the spacer are concentric with each other. The fuse can also be arranged concentrically to the terminal pole and the spacer. For the purposes of the invention, a hazard area is understood to be the area of the battery cell into which conductive particles or hot gases are led from the battery cell in the event of a fault or in which undesired electrical contact is made between the terminal pole and the contact point, for example due to an expansion of the battery cell casing, as a result of other fault-related circumstances. The connecting conductor extends in the main direction over at least the length of the spacer to enable electrical contacting.

The construction effort can be reduced if the electrically conductive spacer forms the connecting conductor. As a result of these measures, no separate connecting conductor needs to be provided, which means that only the spacer needs to pass through the hazard area as the connecting conductor. The spacer must be able to counteract the expansion force of escaping hot gases and must have a corresponding rigidity or physical resistance, which means that it is less likely to be damaged in the event of a fault than a separate connecting conductor. This ensures that the electrical connection to the fuse is maintained until the fuse itself is severed, so that renewed electrical contact in the hazard area does not lead to a renewed electrical connection to the contact point.

The tripping behavior of the fuse can be further improved if the insulation area on the side opposite the hazard area is delimited by a further thermal insulating element. Apart from the direct physical protection, which is improved by the provision of a further insulating element as a physical barrier, the second insulating element also prevents the heat generated in the fuse by the current flow from being dissipated, so that unintentional cooling of the fuse due to external influences can be avoided. Furthermore, a chamber at least partially physically shielded from the contact point is formed between the two insulating elements, which can form a further thermally insulating layer in addition to the thermally insulating properties of the insulating elements. This further prevents the heat released when the fuse melts from being transferred too strongly to the contact point. In a preferred embodiment, this further thermal insulating element is also electrically insulating in order to prevent unintentional electrical contacting of the contact point via this insulating element after the fuse has melted through. The installation height of the device according to the invention can be reduced if the fuse is in contact with one or both insulating elements, which must of course be electrically insulating for this purpose.

Despite its good thermal insulating properties, an insulating element can be easy to manufacture and lightweight if a thermal insulating element is made of mica. Mica has a high melting point and is easy to split, making it easy to produce lightweight and temperature-resistant insulating elements. In addition, the easy fissility of mica makes it possible to produce insulating elements with the desired, precisely defined thickness within low manufacturing tolerances, which can be adapted to the expected material loads. Mica is also electrically insulating. In addition to mica, other materials such as epoxies or ceramics can also be used as materials for the insulating element.

Depending on the situations expected to occur in the event of a fault, the insulation area transverse to the main direction can be delimited at least in sections by a separating element which distances the two thermal insulating elements from each other. As a result of these measures, heat dissipation from the insulation area transverse to the main direction is also reduced, so that the tripping time of the fuse can be better predetermined. If high mechanical loads or vibrations are to be expected during operation, the separating element can be designed not only in sections, but completely around the edge of an insulating element, whereby the relative position of the two insulating elements to each other can be better determined even when mechanical forces are applied.

The contact point can be physically and thermally shielded even better if the thermal insulating element opposite the hazard area rests on a contact spring which engages around the thermal insulating element. The contact spring allows the electrical contact of the contact point to be routed around the edge of the insulating element, which means that no opening in the insulating element is required to make the electrical contact. The contact spring can, for example, contact another battery cell or another electrical conductor, such as a contact plate.

The connecting conductor can be connected particularly easily to both the fuse and the terminal pole if the cross-sectional area of the connecting conductor is at least 75%, preferably at least 80%, even more preferably at least 90% and even more preferably at least 100% of the end face of the terminal pole. Depending on the cross-section of the terminal pole and the connecting conductor, this enables a mechanically stable connection that is easy to manufacture due to the large surface area and also has a lower electrical resistance. Due to the required large cross-sectional area of the connecting conductor compared to the terminal pole, the use of an electrically conductive spacer as the connecting conductor is particularly suitable here, as this not only achieves high mechanical stability, but also low electrical resistance. In a preferred embodiment, the connecting conductor forms a connecting flange for a material bonding to the terminal pole.

If hot gases occur in the event of a fault, they can be deflected away from the insulation layer if the connecting conductor and/or the spacer forms a linear guide for a protective element that can be displaced from a rest position along the main direction into a release position. In the rest position, the protective element covers the area of the battery cell from which hot gases or conductive particles escape in the event of a fault. The pressure of these hot gases causes a displacement of the protective element along the connecting conductor and/or the spacer, which thereby absorbs part of the kinetic energy of the hot gas and deflects it transverse to the main direction. If sufficient kinetic energy is transferred to the protective element, the protective element is moved into the release position, additionally shielding and protecting the insulating element facing the hazard area. If the connecting conductor forms the linear guide for the protective element, its electrical conductivity is not impaired and the electrical connection between the terminal pole and contact point can still be interrupted in a controlled manner via the fuse.

In order to avoid undesired displacement of the protective element, regardless of the spatial orientation of the device or any vibrations, the protective element can be secured against displacement from the rest position under a releasing acceleration of less than 100 g. Tests have shown that unwanted displacement can be avoided at this releasing acceleration, but that the escaping hot gases apply the force proportional to this releasing acceleration in order to cause the protective element to be displaced into the release position. The protective element can be held in the rest position by force, for example by a spring. Alternatively or additionally, the protective element can also be fixed in the rest position by a positive or material connection, whereby a predetermined breaking point can be provided, which breaks when a force corresponding to an acceleration of 100 g is exceeded. The force proportional to the releasing acceleration can be calculated by multiplying the releasing acceleration by the mass of the protective element. For example, the protective element can have retaining tabs that break when the force proportional to the releasing acceleration is exceeded.

The invention also relates to a battery system with a plurality of devices according to the invention adjoining one another transversely to the main direction. In such a battery system, the terminal poles of the devices are arranged at the end faces of end sections of battery cells of a first group and the contact points of the devices form contact springs for contacting, preferably for engaging around the end sections of battery cells of a second group. The devices form a continuous hazard area between the two groups. If a fault occurs in a battery cell that leads to hot gas escaping, the protective element of the protective device placed on this battery cell is moved from the rest position to the release position, which not only prevents the escaping hot gas from reaching the adjacent battery cell in the main direction, but also diverts it into the continuous hazard area. Since the redirected hot gas flow in the immediate vicinity of the outgassing battery cell also has a directional component directed against the main direction due to bouncing off the protective element, the battery cells surrounding it transverse to the main direction are protected by the rest position of the protective elements of the adjacent protective devices. In particular, the hot gas flow is thus kept away from the outgassing areas of the surrounding battery cells, so that a chain reaction of several faults can be effectively avoided.

### BRIEF DESCRIPTION OF THE INVENTION

The drawing shows an example of the object of the invention. It shows

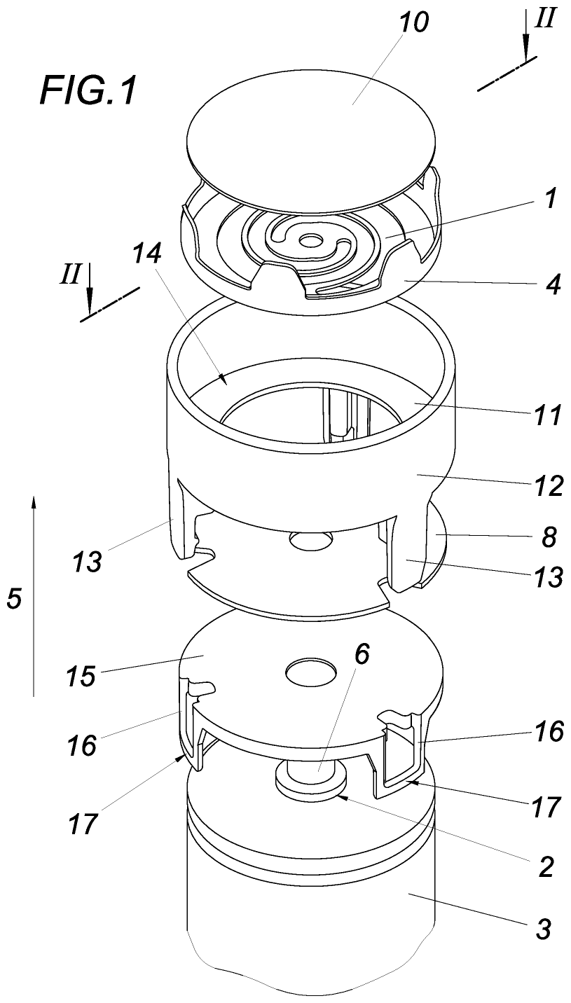

FIG. 1 an exploded view of a device according to the invention and

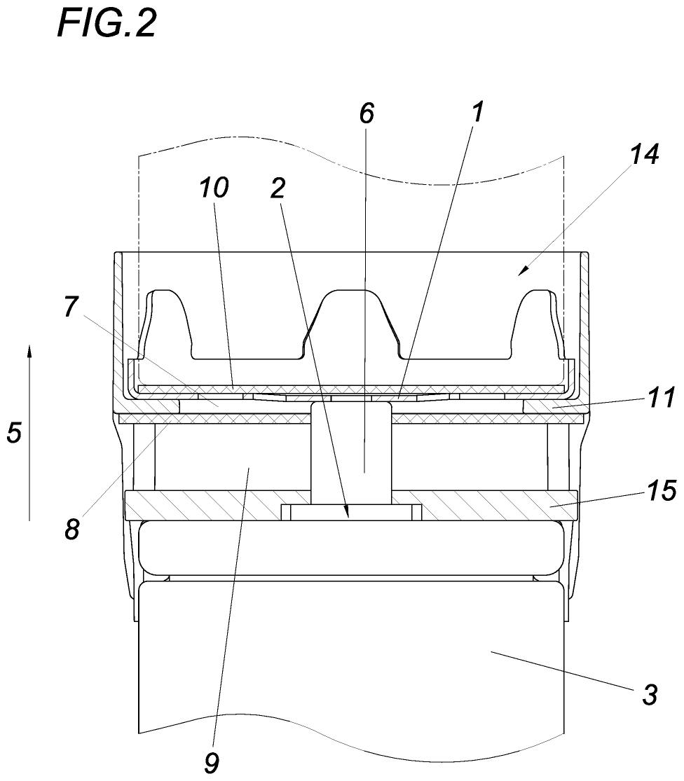

FIG. 2 a section along line II-II of FIG. 1 on a larger scale.

### WAYS TO CARRY OUT THE INVENTION

A device according to the invention comprises a fuse 1 which is electrically connected to the terminal pole 2 of a battery cell 3. On the side opposite the terminal pole 2, the fuse 1 is electrically connected to a contact point 4, which may, for example, be a contact spring for contacting another battery cell shown as a dotted line in FIG. 2. The terminal pole 2 is spaced from the fuse 1 in a main direction 5, whereby the terminal pole 2 is connected to the fuse 1 via a connecting conductor 6. The fuse 1 is arranged within an insulation area 7, which is separated from a hazard area 9 adjacent to the terminal pole 2 by an insulating element 8. Accordingly, the connecting conductor 6 passes through the hazard area 9, as can be seen in particular in FIG. 2.

In the embodiment shown, the connecting conductor 6 forms a spacer that separates the terminal pole 2 from the fuse 1 in the main direction 5.

To improve the tripping conditions of the fuse 1, the insulation area 7 can be delimited by a further insulating element 10 on the side opposite the hazard area 9. Both the insulating element 8 and the insulating element 10 can be a mica disc.

Transverse to the main direction 5, the insulation area 7 can be delimited by a separating element 11, on which the insulating elements 8 and 10 are supported. In a preferred embodiment, the separating element 11 is part of a carrier 12, which has latching arms 13 for a form-fitting and/or force-fitting connection of the battery cell 3. This carrier 12 can form a receptacle 14 for a further battery cell on the side opposite the latching arms 13, as indicated in FIG. 2.

The insulating element 10 can cover the base of the receptacle 14, while the insulating element 10 is laterally engaged around by a contact spring as contact point 4.

In the embodiment shown, the connecting conductor 6 designed as a spacer forms a linear guide for a protective element 15, which can be displaced along the main direction 5 between a rest position and a release position. In addition to the connecting conductor 6 and/or the spacer, the latching arms 13 can also form linear guides for this protective element 15. As can be seen in particular from FIG. 1, the protective element 15 can have retaining tabs 16, which engage around the latching arms 13 in a form-fitting manner and which have a predetermined breaking point 17, which is designed such that it breaks at a releasing acceleration of more than 100 g, so that the protective element 15 can be displaced from the rest position into the release position.

1. A device for electrically contacting a terminal pole of a battery cell, said device comprising:
a fuse electrically connected to the terminal pole and to a contact point spaced from the terminal pole in a main direction;
wherein the fuse is connected to the terminal pole via a connecting conductor and is spaced from the terminal pole in the main direction via a spacer; and
wherein the fuse extends in an insulation area that is separated in the main direction by an insulating element from a hazard area that adjoins the terminal pole and through which the connecting conductor passes.

2. The device according to claim 1, wherein the fuse is spaced from the terminal end by a spacer that is electrically conductive and forms the connecting conductor.

3. The device according to claim 1, wherein the insulation area is delimited by a further insulating element on a side thereof opposite the hazard area.

4. The device according to claim 1, wherein an insulating element consists of mica.

5. The device according to claim 3, wherein the insulation area is delimited transversely to the main direction at least in sections by a separating element that distances the insulating elements from one another.

6. The device according to claim 3, wherein the insulating element opposite the hazard area rests on a contact spring engaging around the insulating element.

7. The device according to claim 1, wherein the connecting conductor has a cross-sectional area that is at least 75% of the end face of the terminal pole.

8. The device according to claim 1, wherein the connecting conductor forms a linear guide guiding a protective element that is supported so as to be displaced from a rest position along the main direction into a release position.

9. The device according to claim 8, wherein the protective element is secured against displacement from the rest position by a releasing acceleration of less than 100 g.

10. A battery system having a plurality of devices, according to claim 1 that adjoin one another transversely to the main direction, wherein the terminal poles of the devices are arranged on the end faces of end sections of battery cells of a first group, and in that the contact points of the devices form contact springs for contacting the end sections of battery cells of a second group.
